(19) United States
(12) Patent Application Publication
(10) Pub. No.: US 2019/0381532 A1
(43) Pub. Date: Dec. 19, 2019

(54) DEVICE FOR NEBULISING A RINSING LIQUID

(71) Applicant: EISENMANN SE, Böblingen (DE)

(72) Inventor: Patrick Kübler, Nagold (DE)

(73) Assignee: Eisenmann SE, Böblingen (DE)

(21) Appl. No.: 16/480,383

(22) PCT Filed: Jan. 25, 2018
(86) PCT No.: PCT/EP2018/051804

§ 371 Date: Jul. 24, 2019

(30) Foreign Application Priority Data
Jan. 25, 2017 (DE) 10 2017 101 370.9

(51) Int. Cl. B05B 15/55; B05B 7/26

(52) U.S. Cl. CPC B05B 15/557; B05B 7/267

(57) ABSTRACT

A device for nebulising a rinsing liquid having a housing and a propellant gas connection, which can be connected to a propellant gas reservoir, and includes a rinsing liquid connection, which can be connected to a rinsing liquid reservoir. There is a mixing chamber and a propellant gas flow path, which connects the propellant gas connection to the mixing chamber, and a propellant gas conveying device, by means of which propellant gas can be fed to the mixing chamber under overpressure. There is also a rinsing liquid flow path, which connects the rinsing liquid connection to the mixing chamber. Nebulised rinsing liquid can be discharged as rinsing fluid from a rinsing fluid discharge connection, which is connected to the mixing chamber. An active rinsing liquid conveying device is provided, by means of which rinsing liquid can be conveyed to the mixing chamber under overpressure.

The invention relates to a device for nebulizing a rinsing liquid with
a) a housing;
b) a propellant gas port which can be connected to a propellant gas reservoir;
c) a rinsing liquid port which can be connected to a rinsing liquid reservoir;
d) a mixing chamber;
e) a propellant gas flow path which connects the propellant gas port to the mixing chamber;
f) a propellant gas conveying apparatus by means of which propellant gas can be supplied with overpressure to the mixing chamber;
f) a rinsing liquid flow path which connects the rinsing liquid port to the mixing chamber;
g) a rinsing liquid output port which is connected to the mixing chamber and out of which nebulized rinsing liquid can be output as rinsing fluid.

In the case of painting of articles by means of coating systems, an application apparatus, which in the case of coating processes can be, for example, a high-speed rotational atomizer or a spray gun, is supplied with liquid material. These can be on one hand liquid coating materials, in particular paints which are applied onto an article to be coated.

On the other hand, solvents, rinsing agents or parting agents also flow through the flow path to the application apparatus and are, where applicable, also output from these. Thus, for example, in the event of a change in material, the ducts and lines which conduct material have to be cleaned of the previously used paint, to which end a rinsing agent is conveyed through the corresponding ducts and lines. For example, in the case of a paint shop, a changeover apparatus for coating materials, i.e. a paint changeover apparatus, is used for such a change in material if it arises more frequently during normal operation that a different paint is supposed to be used for coating an article than that paint with which a previous article was painted. For this purpose, the rinsing fluid output port is connected to the line to be cleaned or the system to be cleaned.

It is known from DE 4 214 777 A1, DE 10 129 667 A1 or U.S. Pat. No. 4,881,563 A that a good cleaning action can be achieved in the case of media-conducting lines if atomized or nebulized detergent flows into the lines.

For this purpose, for example, in the case of DE 4 214 777 A1, rinsing agent and air are introduced with inverse twist into the flow path, as a result of which nebulization of the rinsing agent occurs.

The object of the invention is to create a device of the above-mentioned type which achieves good nebulization of a rinsing liquid and thus enables effective cleaning of media-conducting lines and ducts.

This object is achieved in that
h) an active rinsing liquid conveying device is present by means of which rinsing liquid can be supplied with overpressure to the mixing chamber.

The invention is based on the knowledge that an active supply of the rinsing liquid to the propellant gas and into the mixing chamber leads to a particularly effective nebulization of the rinsing liquid. In the case of known concepts, in contrast to the invention, a passive supply of the rinsing liquid is used in the case of which, according to the Venturi principle, a vacuum is generated by the flowing propellant gas in the mixing chamber, as a result of which vacuum the rinsing liquid is then sucked in.

It is expedient if a collection nozzle is arranged in the flow path between the rinsing fluid output port and the mixing chamber. As a result of such a collection nozzle, the mixture generated in the mixing chamber of propellant gas and rinsing liquid can once again be accelerated and additionally caused to swirl and be nebulized.

Here, the collection nozzle preferably has a flow duct with a first flow portion which tapers in the direction of flow and opens into a second flow portion with a constant cross-section which forms a transition into a third flow portion which expands in the direction of flow. The second flow portion with a constant cross-section can also be defined only by the transition point between the first flow portion and the third flow portion.

Good acceleration values can be achieved if the cross-section of the second flow portion with a constant cross-section is approximately 3.2 mm².

A good mixing through of rinsing liquid and propellant gas is achieved if rinsing liquid and propellant gas enter at an angle, preferably at an angle of 90°, to one another into the mixing chamber and intersect in the mixing chamber.

It is advantageous if the active rinsing liquid conveying apparatus is configured in such a manner that rinsing liquid enters with a pressure of 4 bar to 12 bar, preferably with a pressure of 6 bar to 10 bar and particularly preferably with a pressure of approximately 8 bar into the mixing chamber.

It is furthermore advantageous if the propellant gas conveying apparatus is configured in such a manner that propellant gas enters with a pressure of 4 bar to 12 bar, preferably with a pressure of 6 bar to 10 bar and particularly preferably with a pressure of approximately 8 bar into the mixing chamber.

It is expedient if a rinsing liquid bypass line is provided by means of which rinsing liquid can be guided past the mixing chamber to the rinsing fluid output port. In this manner, rinsing liquid can be pushed directly into a connected line or a connected system in order to detach and remove stubborn contamination.

It is furthermore expedient if a pulse apparatus and a propellant gas pulse line are provided so that a pulse propellant gas can be generated and can be injected via the propellant gas pulse line into the mixing chamber. In this manner, rinsing fluid packs with high pressure and good cleaning action can be output by the device.

It is particularly expedient if a temperature-control apparatus with at least one temperature-control element is provided on or in the propellant gas flow path and/or on or in the rinsing liquid flow path, with which temperature-control apparatus propellant gas and/or rinsing liquid can be temperature-controlled. It is thus made possible that heated rinsing fluid is generated, as a result of which the cleaning action can be further improved.

For this purpose, the temperature-control apparatus is preferably a heating apparatus.

This can be achieved technically effectively in that the temperature-control apparatus is an inductive heating apparatus and the temperature-control element is a heating coil which can be passed by propellant gas and/or rinsing liquid.

Alternatively, the temperature-control apparatus can comprise as a temperature-control element a heat exchanger unit or a Peltier element. In this manner, propellant gas and/or rinsing liquid can be heated up, but also cooled, should this be necessary.

Exemplary embodiments of the invention are explained in greater detail below on the basis of the drawings. In these drawings:

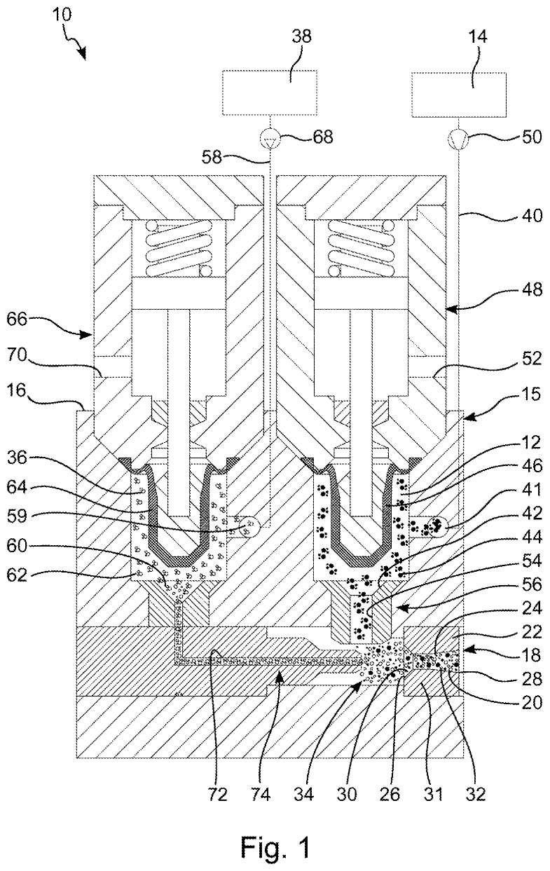

FIG. 1 shows a section of a device for nebulizing a rinsing liquid according to a first exemplary embodiment;

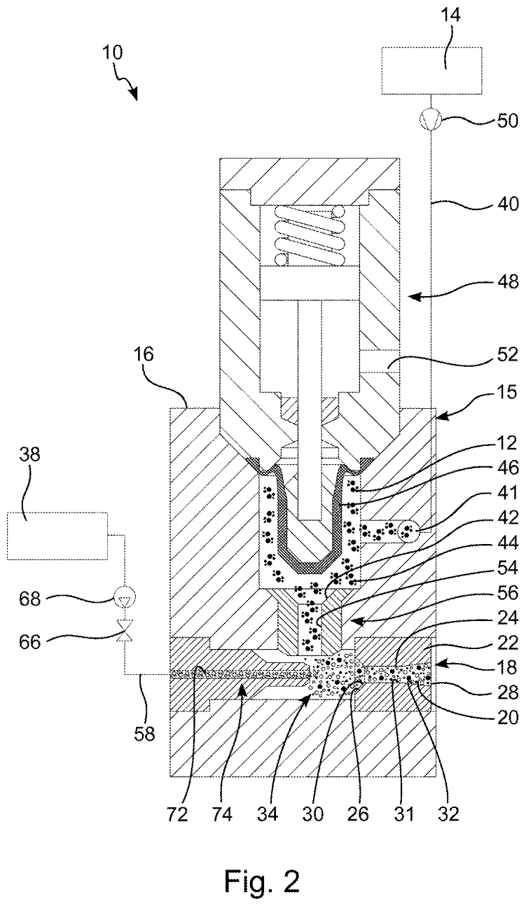

FIG. 2 shows a section of a device for nebulizing a rinsing liquid according to a second exemplary embodiment;

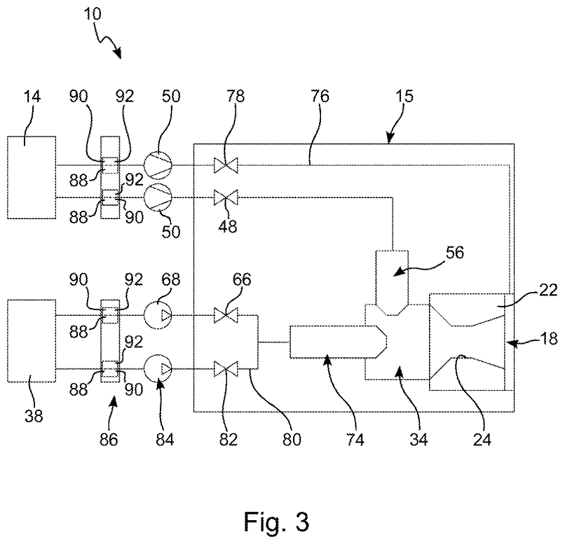

FIG. 3 schematically shows the device for nebulizing a rinsing liquid with further components.

Reference is first made to FIG. 1. A device 10 is shown there with which a rinsing liquid 12 from rinsing liquid reservoir 14 is nebulized.

In the present case, the term reservoir refers to any technical solution for providing or receiving different media. These thus include, for example, annular line systems, as are known per se.

Device 10 comprises an injector 15 with a housing 16 formed as a housing block with a rinsing fluid output port 18 to which a line to be cleaned or a system to be cleaned or also only a part of such a system can be connected. Such a system to be cleaned is in practice a paint application system with the components involved with media-conducting lines and ducts. The connection can also be performed via a connection line which itself does not belong to the system to be cleaned. Nebulized rinsing liquid 12 in any event exits as rinsing fluid 20 out of device 10 via the rinsing fluid output port.

A collection nozzle 22 is arranged upstream of rinsing fluid output port 18, which collection nozzle 22 has a flow duct 24 which extends between an input opening 26 and an output opening of collection nozzle 22. Flow duct 24 has a first flow portion 30, the cross-section of which tapers linearly in the direction of flow from input opening 26 in the direction of output opening 28 and opens into a second flow portion 31 with a constant cross-section which then forms a transition into a third flow portion 32 which again expands linearly in the direction of flow, i.e. in the direction of output opening 28. In the case of the present exemplary embodiment, the cross-sections of flow portions 30, 31, 32 are circular, wherein the constant cross-section of second flow portion 31 has a diameter of approximately 2 mm and thus a cross-section of approximately 3.2 mm². Second flow portion 31 with a constant cross-section can also be defined only by a transition point between first flow portion 30 and third flow portion 32. In the case of modifications which are not shown separately, the cross-sections of first flow portion 30 and of third flow portion 32 can also taper or expand in a non-linear manner.

A mixing chamber 34, to which rinsing liquid 12 from rinsing liquid reservoir 14 and a propellant gas 36 from a propellant gas reservoir 38 can be supplied, adjoins input opening 26 of collection nozzle 22. Collection nozzle 22 is thus arranged in the flow path between rinsing fluid output port 18 and mixing chamber 34. In the case of the present exemplary embodiment, mixing chamber 34 has a volume of approximately 112.5 mm³ and is cylindrical in the case of a length of 9 mm and a cross-section of 12.5 mm². In practice, mixing chambers 34 with lengths between 1 mm and 15 mm and cross-sections between 12.5 mm² and 50 mm² lead to good results.

On one hand, for this purpose, a rinsing liquid supply line 40 is connected via a valve seat 42 and a valve seat chamber 44 for a sealing element 46 of a first compressed air-activated valve to mixing chamber 34. Rinsing liquid supply line 40 is connected via a rinsing liquid port 41 to the housing 16 and is fed with rinsing liquid 12 in the case of the exemplary embodiment explained here by means of an active rinsing liquid conveying apparatus 50 in the form of a conveying pump out of rinsing liquid reservoir 14. In a release position shown in FIG. 1, first valve 48 releases the flow path from valve seat chamber 44 into mixing chamber 34, to which end compressed air acts upon it via a first compressed air line 52. Without the supply of compressed air, sealing element 46 occupies, as a result of spring pretensioning, a closing position in which it seals off with respect to valve seat 42. Such compressed air-activated valves are generally known, which is why further details in this regard are dispensed with.

A flow duct 54 through which rinsing liquid 12 flows from valve seat 42 to mixing chamber 34 runs between valve seat 42 and mixing chamber 34 so that a rinsing liquid nozzle 56 is formed overall with which rinsing liquid 12 can be injected into mixing chamber 34. Flow duct 54 for rinsing liquid 12 has a diameter which in the present exemplary embodiment is approximately 2.5 mm to 3 mm. Overall, a flow path for rinsing liquid 12 is formed from rinsing liquid port 41 to mixing chamber 34, which flow path comprises valve seat 42, valve seat chamber 44 and flow duct 54.

On the other hand, for the supply of propellant gas 36, a propellant gas supply line 58 is connected via a valve seat 60 and a valve seat chamber 62 for a sealing element 64 of a second compressed air-activated valve 66 to mixing chamber 34. Propellant gas supply line 58 is connected via a propellant gas port 59 to housing 16 and is fed with propellant gas 36 by means of an active propellant gas conveying apparatus 68 from the propellant gas reservoir 38. Propellant gas 36 is in practice air and propellant gas conveying apparatus 68 is a compressor; propellant gas 36 is blown with overpressure into mixing chamber 34. Propellant gas conveying apparatus 68 is configured here such that propellant gas 36 enters with a pressure of 4 bar to 12 bar, preferably with a pressure of 6 bar to 10 bar and particularly preferably with a pressure of approximately 8 bar into mixing chamber 34.

In a release position shown in FIG. 1, second valve 66 releases the flow path from valve seat chamber 62 into mixing chamber 34, to which end it is acted upon with compressed air via a second compressed air line 70. Sealing element 64 of second valve 66 also occupies a closing position without compressed air supply as a result of spring pretensioning; it seals off with respect to valve seat 60 here.

A flow duct 72 runs between valve seat 60 and mixing chamber 34, through which flow duct 72 propellant gas 36 flows from valve seat 60 to mixing chamber 34 so that overall a propellant gas nozzle 74 is formed by which propellant gas 36 can be injected into mixing chamber 34. Flow duct 72 has a comparatively small cross-section which in the case of the present exemplary embodiment is 1 mm. Propellant gas nozzle 74 injects propellant gas 36 in the direction of input opening 26 of collection nozzle 22 into mixing chamber 34, wherein flow duct 72 in the case of the present exemplary embodiment runs at least in one output portion 72a coaxially to flow duct 24 of collection nozzle 22. Overall, a flow path for propellant gas 36 is formed from propellant gas port 59 to mixing chamber 34, which flow path comprises valve seat 60, valve seat chamber 62 and flow duct 72.

Flow duct 54 of rinsing liquid nozzle 56 and flow duct 72 of propellant gas nozzle 74 run at an angle to one another and are arranged so that the flows of rinsing liquid 12 and of propellant gas 36 enter at an angle to one another into mixing chamber 34 and intersect so that a premixing of rinsing liquid and propellant gas 36 arises. In the case of the present exemplary embodiment, flow ducts 54 and 72 and as a result the flows of rinsing liquid 12 and of propellant gas 36 run at an angle of 90°.

The arrangement of propellant gas nozzle 74, mixing chamber 34, collection nozzle 22 and rinsing liquid nozzle 56 is formed in the manner of a Venturi nozzle which is known per se, which is why the supply of rinsing liquid 12 can be brought about without rinsing liquid conveying pump 50 in that a vacuum is generated by the flow of propellant 36 in mixing chamber 34, by means of which vacuum rinsing liquid 12 is sucked out of rinsing liquid reservoir 14 into mixing chamber 34, in the case of which pressure equalization must correspondingly be ensured. Conveying of rinsing liquid 12 would therefore be carried out passively in such a case.

In the case of the present exemplary embodiment, rinsing liquid 12 is, however, supplied actively with an overpressure to mixing chamber 34 in contrast to the Venturi principle with the aid of rinsing liquid conveying pump 50. Active rinsing liquid conveying apparatus 50 is configured in such a manner that rinsing liquid 12 enters with a pressure of 4 bar to 12 bar, preferably with a pressure of 6 bar to 10 bar and particularly preferably with a pressure of approximately 8 bar into mixing chamber 34. In mixing chamber 34, pressurized rinsing liquid 12 strikes propellant gas 36 and is already effectively nebulized there. A highly turbulent propellant gas/rinsing liquid mixture is thus generated which, depending on the type of rinsing liquid 12 used, is, for example, a foam or a mist.

This mixture flows into collection nozzle 22, where it is once again accelerated and additionally nebulized in order then to exit out of device 10 as rinsing fluid 20.

In the case of the exemplary embodiment shown in FIG. 1, valves 48 and 66 are accommodated in housing 16. In a modification thereto, it is, however, also possible that one or both of these valves 48, 66 are not encompassed by injector 10, rather are arranged separately therefrom. In particular, a valve 48, 66 provided separately from injector 10 is then arranged as a switching valve in associated rinsing liquid supply line 40 or in associated propellant gas supply line 58.

FIG. 2 shows a modification in which it is the case that second valve 66 is arranged there in propellant gas supply line 58. As a result of this measure, injector 10 can be formed to be more compact overall than in the case that one or both of valves 48, 66 are accommodated in housing 16 and are encompassed by injector 10 as an assembly.

FIG. 3 again schematically illustrates additions in the case of the exemplary embodiments described above according to FIGS. 1 and 2 of device 10 with injector 15, wherein only the key components are represented in a highly simplified form and provided with a reference number.

In addition to the flow path of rinsing liquid 12 to mixing chamber 34, a rinsing liquid bypass line 76 is provided which can be connected to rinsing liquid reservoir 14 and conducted past mixing chamber 34 to rinsing fluid output port 18 so that pure, non-nebulized rinsing liquid 20 can also be output there. This may be necessary, for example, in the case of particularly stubborn contaminations in the system to be cleaned which cannot adequately be removed with rinsing fluid 22, i.e. nebulized rinsing liquid 12. A valve 78 is arranged in rinsing liquid bypass line 76. Rinsing liquid bypass line 76 can be formed as a corresponding flow duct in housing 16.

Moreover, a propellant gas pulse line 80, which is also connected to propellant gas nozzle 74 and is assigned a separate valve 82, is present in addition to the flow path of propellant gas 36 to mixing chamber 34. In a manner known per se, a pulse apparatus 84 is present so that a pulse propellant gas, in general pulse air, can be generated and injected via propellant gas pulse line 80 and propellant gas nozzle 74 into mixing chamber 34. The pulse air can be used to output mixture volumes generated in mixing chamber 34 of propellant gas 36 and rinsing liquid 12 with high pressure out of injector 10 and blown into a system to be cleaned. Only the key components are provided with a reference number in FIG. 3.

FIG. 3 furthermore shows that device 10, in the case of all the embodiments, can comprise on or in the propellant gas flow path and/or on or in the rinsing liquid flow path a temperature-control apparatus 86 with which propellant gas 36 and/or rinsing liquid 12 can be temperature-controlled and in particular heated up so that rinsing fluid 20 leaves device 10 at rinsing fluid output port 18 as heated rinsing fluid. As a result of this, the cleaning action of rinsing fluid 20 is further increased in comparison to rinsing fluid 20 which has not been heated.

Temperature-control apparatus 86 comprises one or more temperature-control elements 88 and is designed in the case of the present exemplary embodiment as an inductive heating apparatus, the temperature-control elements 88 of which are heating elements 90 in the form in each case of a heating coil 92. Heating coils 92 surround in each case the media-conducting lines so that heating coils 92 can be passed by propellant gas 36 and/or rinsing liquid 12.

In the case of modifications not shown separately, respective heating element 90 can also be formed differently. For example, a radiation source is also considered.

Alternatively or additionally, temperature-control elements 88 can also be present which can in principle heat up and cool down. For this purpose, a temperature-control element 88 can be, for example, a heat exchanger unit or in particular a Peltier element, the technology of which is known per se. Pure cooling elements can also be present.

What is claimed is:

1. A device for nebulizing a rinsing liquid, comprising: with
a) a housing;
b) a propellant gas port which can be connected to a propellant gas reservoir;
c) a rinsing liquid port which can be connected to a rinsing liquid reservoir;
d) a mixing chamber;
e) a propellant gas flow path which connects the propellant gas port to the mixing chamber;
f) a propellant gas conveying apparatus by means of which propellant gas can be supplied with overpressure to the mixing chamber;
f) a rinsing liquid flow path which connects the rinsing liquid port to the mixing chamber;
g) a rinsing liquid output port which is connected to the mixing chamber and out of which nebulized rinsing liquid can be output as rinsing fluid,
wherein
h) an active rinsing liquid conveying apparatus is present by means of which rinsing liquid can be supplied to the mixing chamber with overpressure.

2. The device as claimed in claim 1, wherein a collection nozzle is arranged in the flow path between the rinsing fluid output port and the mixing chamber.

3. The device as claimed in claim 2, wherein the collection nozzle has a flow duct with a first flow portion which tapers in a direction of flow and opens into a second flow portion with a constant cross-section which forms a transition into a third flow portion which expands in the direction of flow.

4. The device as claimed in claim 3, wherein the cross-section of the second flow portion with a constant cross-section is approximately 3.2 mm².

5. The device as claimed in claim 1, wherein rinsing liquid and propellant gas enter at an angle to one another into the mixing chamber and intersect in the mixing chamber.

6. The device as claimed in claim 1, wherein the active rinsing liquid conveying apparatus is configured in such a manner that rinsing liquid enters with a pressure of 4 bar to 12 bar, into the mixing chamber.

7. The device as claimed in claim 1, wherein the propellant gas conveying apparatus is configured in such a manner that propellant gas enters with a pressure of 4 bar to 12 bar into the mixing chamber.

8. The device as claimed in claim 1, wherein a rinsing liquid bypass line is provided by means of which rinsing liquid can be guided past mixing chamber to the rinsing fluid output port.

9. The device as claimed in claim 1, wherein a pulse apparatus and a propellant gas pulse line are provided so that a pulse propellant gas can be generated and can be injected via the propellant gas pulse line into the mixing chamber.

10. The device as claimed in claim 1, wherein a temperature-control apparatus with at least one temperature-control element is provided on or in the propellant gas flow path and/or on or in the rinsing liquid flow path, with which temperature-control apparatus propellant gas and/or rinsing liquid can be temperature-controlled.

11. The device as claimed in claim 10, wherein temperature-control apparatus is a heating apparatus.

12. The device as claimed in claim 11, wherein the temperature-control apparatus is an inductive heating apparatus and the at least one temperature-control element is a heating coil which can be passed by propellant gas and/or rinsing liquid.

13. The device as claimed in claim 1, wherein a temperature-control apparatus is provided, wherein the temperature-control apparatus comprises as a temperature-control element a heat exchanger unit or a Peltier element.

14. The device as claimed in claim 5, wherein the angle is 90°.

15. The device as claimed in claim 6, wherein the active rinsing liquid conveying apparatus is configured in such a manner that rinsing liquid enters with a pressure of 6 bar to 10 bar.

16. The device as claimed in claim 15, wherein the active rinsing liquid conveying apparatus is configured in such a manner that rinsing liquid enters with a pressure of 8 bar.

17. The device as claimed in claim 7, wherein the propellant gas conveying apparatus is configured in such a manner that propellant gas enters with a pressure of 6 bar to 10 bar.

18. The device as claimed in claim 17, wherein the propellant gas conveying apparatus is configured in such a manner that propellant gas enters with a pressure of approximately 8 bar.
